(19) United States
(12) Patent Application Publication
(10) Pub. No.: US 2004/0007880 A1
(43) Pub. Date: Jan. 15, 2004

(54) Wave energy converter using an oscillating mass

(76) Inventor: Michael Joseph French, Lancaster (GB)

Correspondence Address: Michael Joseph French, 4 Haverbreaks Place, Lancaster, LAI 5BH, GB

(21) Appl. No.: 10/380,616

(22) PCT Filed: Sep. 12, 2001
(86) PCT No.: PCT/GB01/04069

(30) Foreign Application Priority Data
Sep. 15, 2000 (GB) 00226415

(51) Int. Cl. F03B 13/10; H02P 9/04

(52) U.S. Cl. 290/53; 290/42; 290/43

(57) ABSTRACT

Wave energy converters having a paddle form and facing the seas have been described in papers, previous designs having a sliding mass located low in the hull. Power is taken off by resisting the movement of the sliding mass. In this invention, the sliding mass is located high in the hull, generally above sea level, where it is more effective and so may have a substantially lower mass. In addition, instead of moving in a straight line, means may be provided for the slide to be curved in the vertical plane to improve performance. Further, the guiding means may be a pivoted arm or a linkage, rather than a slide, and the path may be variable to suit the period of the waves.

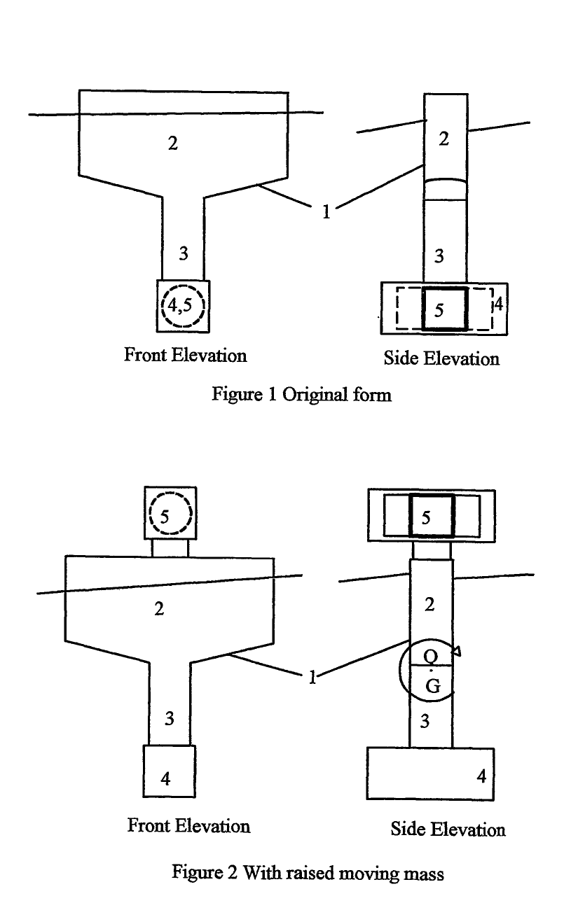

It has been proposed to extract useful energy from sea waves by a device (FIG. 1) consisting of a paddle 1 floating almost fully immersed in the sea and facing the oncoming waves. The paddle has a large blade 2 on a relatively slender shaft 3 and is ballasted at the bottom at 4 so that it pitches about its centre of mass G (FIG. 1) at roughly the mean frequency of the oncoming waves. G is the effective centre of mass, taking into account of the added masses due to the surrounding water, and it is the centre of pitch. Means are provided to apply a pitching moment Q to the paddle, causing it to move in a combination of pitch and surge (where these terms are used as in ship dynamics and aeronautics, with the ‘bows’ or ‘nose’ the front or wave side of the paddle (see FIG. 1). In a regular sea, that is, one of unvarying wave period, if this moment varies harmonically and has the right amplitude and frequency, then the power delivered by the moment is the maximum or ideal power, which is the incident power in a wavefront of length (wavelength/π). This theoretical ideal power capture has been derived by several workers in the field (e.g., ref. 1) and has been achieved in tests on models in wave tanks (ref.2). The dynamical rationale of the general approach is given at length in ref.3.

Two ways of generating the required moment have been proposed, gyroscopes and a sliding mass. In the long run, gyroscopes may provide the best means but in the medium term the development using the sliding mass seems more attractive.

This invention concerns improvements in the sliding mass method. The sliding mass moves under the restraint of hydraulic cylinders which provide the power take-off and also the means of controlling the motion in quasi-resonance (see section 8 and section 10 onwards).

The earlier designs produced by the inventor and his colleagues are described in various papers (e.g., refs. 2,4). They have displacements of the order of 1500 tonnes and sliding masses of the order of 500-1500 tonnes. The sliding mass (5 in FIG. 1) slides fore and aft and is located at the bottom of the device. In this location it has the additional function of providing much of the ballast necessary to provide the required pitching frequency.

The first part of the invention is to place the sliding mass at the top of the paddle or even higher, as in FIG. 2, where the sliding mass is at 5. This has immediate and obvious disadvantages, because it raises G, which must be kept low, and so more ballast must be added at the bottom both to replace the original sliding mass and then to restore the position of G. What the inventor failed to notice until last year is the advantage of a high position of the sliding mass, which is that it greatly reduces the amount of sliding mass needed, as the analysis below shows. What is more, with the mass at the bottom, it is difficult to provide good capture over the whole range of wave periods. This difficulty almost disappears with a high position of the sliding mass, which gives good capture over a wider range of seas and increases the average power for the same electrical rating. These advantages will usually outweigh the disadvantage of increased displacement, which may only mean a slight increase in steel content which is more than offset by a further advantage. With the sliding mass positioned high, there is no need for its container to be able to withstand a high external hydrostatic pressure, so that it can be of lighter construction.

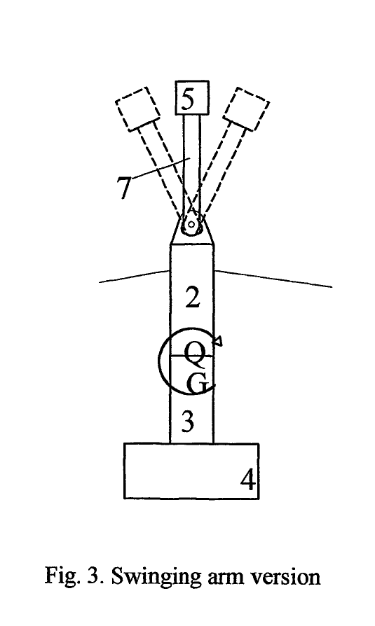

One way of reducing the sliding mass is to increase its travel, but this involves a bigger container if the mass is below water. However, if the sliding mass is in the air well above the sea no container is required, simply guides. The simplest embodiment of this notion is an arm 7, pivoting about a pitching (athwartship) axis 8 at or near the top of the paddle (FIG. 3) and carrying the moving mass 5 at its upper end.

With such an arrangement it becomes practical to increase the travel of the moving mass by a factor of two or more, and hence reduce it to, say, one tenth of its former value. The moving mass required is divided by a factor which is the sum of two terms (see analysis, section 10 onwards), one of which increases as the length of the arm and the other as the square of the length of the arm. Hence the mass decreases more than in inverse proportion to the arm length.

Putting the moving mass outside the hull in this way loses the feature of having no external parts, but since there need be just one moving seal and that can be above sea level, and since the moving parts are not usually immersed, the loss is chiefly one of elegance.

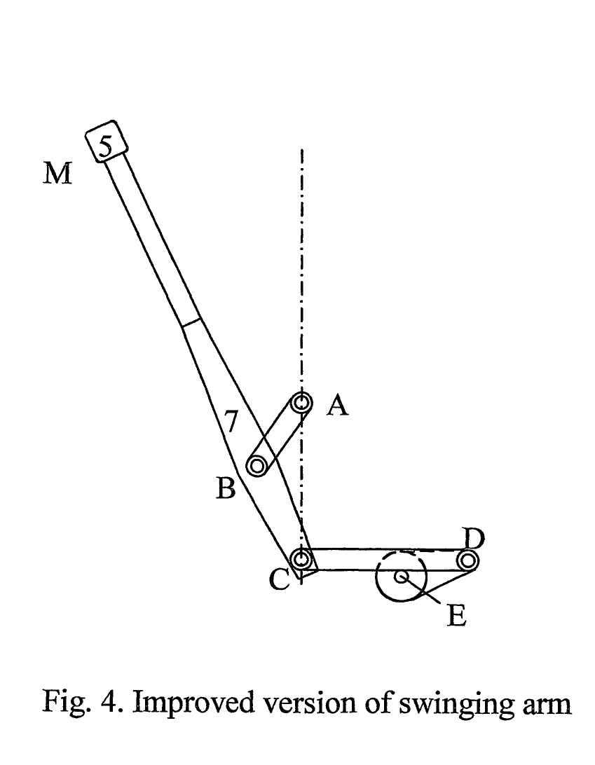

There is a difficulty with the swinging arm, which is the rise and fall of the moving mass, which involves the hydraulic cylinders doing work to raise the mass. The power they put out is later returned, but only after having been reduced by frictional losses. These losses can be obviated by making the mass move on a roughly straight line by substituting a mechanism for the simple pivot. Such a mechanism is shown in FIG. 4.

A further advantage that can be added to the high sliding mass feature concerns the important aspect of dynamic tuning (ref 2). In order to obtain economical amounts of power it is necessary to keep the amplitude of the working surface as high as possible. To do this, the device must be maintained in ‘resonance’, or rather quasi-resonance, since the waves that excite the motion are not at a regular frequency. To do this, it is necessary to modify the motion from simple harmonic to maintain the phase relation between the irregular wave force and the working surface, which in this device is the whole face of the paddle. This modification within the period of a wave is called ‘dynamic tuning’. It is effected in the original version by using the hydraulic cylinders to apply loads to the sliding mass described as reactive, which are 90° out-of-phase with the power extraction loads. Unfortunately, although ideally the net energy flow in this reactive loading is zero, because of the inefficiencies involved in cylinders, accumulators etc., some power is lost.

To reduce the amount of dynamic tuning required, and hence these losses, it has been proposed in the past by the inventor to adjust the natural frequency of the system to match the average frequency of the waves by raising and lowering its centre of gravity by moving water ballast to higher or lower tanks, with or without changing the total amount of water ballast. This ‘slow tuning’ is much too slow to replace dynamic tuning, but it can reduce the amount of dynamic tuning required.

The effect of the curvature of the path of the moving mass in the swinging arm arrangement of FIG. 3 is similar to that of a permanent measure of dynamic tuning. Accordingly, one way of compensating for it is to ‘slow’ tune to a frequency differing from the average wave frequency such that this permanent amount of dynamic tuning just brings the frequency of the system to the average frequency of the waves.

In another arrangement, two swinging arms are used, side by side athwartships. By controlling them independently a yawing moment can be applied, to suppress unwanted motions or to exercise a steering effect to control the direction in which the paddle faces. In this arrangement, it may be desirable to incline the axes of the pivots of the arms downwards at the outer ends, while keeping the arms more or less upright, so that they sweep out conical surfaces. The effect is to reduce the upward curvature of the path of the masses, while introducing a sideways curvature which has little effect on the dynamics.

Where the sliding mass travels in a straight fore-and-aft line, as in FIGS. 1 and 2, some reactive energy transfer occurs to and from the potential and kinetic energy of the mass and the rest of the system. By varying the path of the mass from the straight line relative to the hull, some of the dynamic tuning can be done. A means of doing this is shown in FIG. 4. A helpful way of looking at this is that the reactive force could be provided by a spring of suitable stiffness acting between the sliding mass and its central position. The four-bar chain ABCD in the arrangement of FIG. 4 can be dimensioned so as to make the path of the mass at the end of the arm approximate to a parabola. If the parabola is concave upwards, then the arm will tend to centralize itself, equivalent to a spring of positive stiffness. If the path of the mass is concave downwards, then the effect is equivalent to a spring of negative stiffness. The joint D of the four-bar chain is fixed to the crank 7 which turns about E. By adjusting this crank the path of the mass can be altered, so enabling considerable dynamic tuning without resort to reactive forces from the hydraulic cylinders.

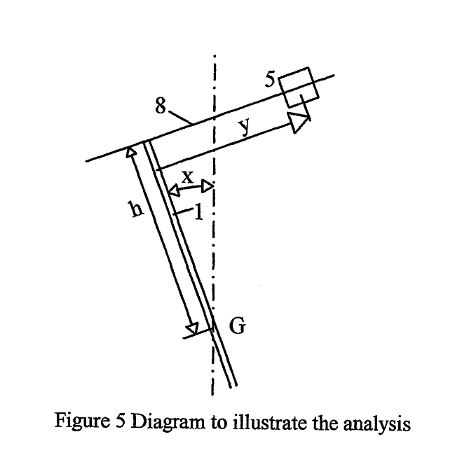

The dynamics of the device will now be given sufficiently for the foregoing remarks to be understood, and for this purpose the following notation will be used, in conjunction with FIG. 5, which shows a vastly simplified version of the device, with a straight line path (9) for the moving mass.

g acceleration due to gravity

h distance of path (8) above G

m mass of sliding mass

t time

y=Y cos ωt distance of moving mass (5) from midpoint of path 8

x=X cos ωt angle of pitch

I moment of inertia about G of the device, including m at midpoint

ω angular frequency of forcing waves

ω₀ natural angular frequency of device

The y motion discussed here is that required for dynamic tuning. Another component of y, in quadrature, is used to resist the wave forces. Since I includes the mass m at the centre of its travel, it is only the relative movement y which needs to be considered, and this exerts a moment about G due to both gravity, with army, and acceleration, due to arm h (displacements are taken as small). Assume that the forcing frequency ω is greater than the natural frequency ω₀, so that the righting moment needs to be assisted in order to maintain the phase, by an amount

I(ω²−ωₒ²). (1)

The torque available consists of an term due to the acceleration of m and one due to the weight of m, totalling

ω²mh+mgy. (2)

The two terms add when h is positive, but subtract in the original design with the sliding mass below G (as in FIG. 1). The moment in quadrature to this dynamic tuning moment, which extracts power, has the same form which summarizes the advantage of the new arrangement. The new arrangement improves the effectiveness of the sliding mass for both power extraction and dynamic tuning, enabling it to be greatly reduced (typically by a factor of 2-3 for the form shown in FIG. 2, and even more for those in FIGS. 3 and 4).

### REFERENCES

1. Evans, D V, A theory for wave power absorption by oscillating bodies, J. Fluid Mechanics, 1976, 77(1),1-25

2. French, M J, and Bracewell, R H, A point-absorber wave energy converter working in a pitch/surge mode, Inst Elec Engrs 5th International Conf. on Energy Options, Univ. of Reading, 7-9 April 1987

3. French, M J, Tadpole: a design problem in the mechanics of the use of sea wave energy, Proc Instn Mech Engrs vol 210, p 273-277

4. French, M J, Latest developments in wave energy at Lancaster, in Wave energy, 1991 Mechanical Engineering Publications, London)

1. A wave energy collector having a floating pendulous paddle, facing the oncoming waves, with power taken off via a mass able to move normally to the face of the paddle, such has been proposed before [1], but in the invention the sliding mass is placed as high as is convenient, rather than as low as possible, as originally proposed. The sliding mass may have wheels or rollers running on rails, and its motion is resisted or sometimes aided by hydraulic rams, electrical machines or other known means, and it travels in a substantially straight line. Typically in the improved version the moving mass will be above water level.

2. A wave energy collector as in claim 1, in which the path of the mass is not straight, but a smooth curve chosen to improve the performance. This curve may be achieved by curving the rails or by means of a linkage, such as a four-bar chain.

3. A wave energy collector as in claims 1 and 2, in which the form of the curve followed by the moving mass may altered from instant to instant, as may be done by a suitable linkage, in order to improve the performance.
